(19) United States
(12) Patent Application Publication
(10) Pub. No.: US 2009/0127176 A1
(43) Pub. Date: May 21, 2009

(54) Modular Water Treatment Unit

(76) Inventor: Ian Geoffrey Cummins, Gaven Queensland (AU)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 11/921,220

(22) PCT Filed: Jun. 1, 2006
(86) PCT No.: PCT/AU2006/000729

§ 371 Date: Nov. 29, 2007

(30) Foreign Application Priority Data
Jun. 1, 2005 (AU) 2005902800
Jun. 21, 2005 (AU) PCT/AU2005/000878
Sep. 16, 2005 (AU) PCT/AU2005/001429

(51) Int. Cl. B01D 29/00; C02F 1/78; C02F 1/32

(52) U.S. Cl. 210/192; 210/255; 210/242.1

(57) ABSTRACT

A modular water treatment unit including a modular tank having a plurality of joined tank parts defining respective chambers arranged in series for treating water, each tank part having opposite side walls with adjacent side walls of adjacent said tank parts being joined at their common upper ends which define weirs over which water being treated in the unit may flow from one tank part to the adjacent tank part for treatment in the respective chambers. The modular water treatment unit may be associated with a floatable support for floating in or on a body of water for treating water therein.

### TECHNICAL FIELD

This invention relates to a modular water treatment unit and in particular to a modular water treatment unit for treating water for the purposes of purifying, cleaning or others removing impurities or contaminants in water. The present invention also relates to water treatment apparatus including a modular water treatment unit for use in treating a body of water or in other water treatment applications.

### BACKGROUND ART

The treating of water for the purposes of purifying the water or removing contaminants from water has become an increasing problem to growing communities where increasing volumes of effluent or contaminated water is generated. Contaminated water can be generated in domestic, commercial and agricultural situations including in aquaculture. Often contaminated water receives primary treatment and is then simply left in settling ponds where solids settle out. With water shortages it is highly desirable that contaminated water be treated so as to enable it to be reused or recycled. It is also desirable to be able to treat water in a body of water including a water reservoir to maintain the water therein in a relatively uncontaminated state.

Automated and non-automated vehicle washing apparatus use considerable quantities of water in washing vehicles. Water which is used in the vehicle washing process can be contaminated with soap and detergent suds used in the washing process as well as grease, oil, brake pad dust, road grime and other contaminants. Furthermore, a considerable volume of water is used in the washing process which is obviously undesirable from the point of view of water conservation. It would be desirable therefore to have an effective means for reusing or recycling water used in vehicle washing apparatus for the purposes of conserving water. Difficulties however are encountered in reusing water from vehicle washing apparatus because of the contaminates in the water used in the washing process.

### SUMMARY OF THE INVENTION

The present invention aims to provide a modular water treatment unit which may be used in many different water treatment applications. The present invention in a further aspect aims to provide water treatment apparatus including a modular water treatment unit which may be used on a body of water for treating water therein. The present invention in a further aspect aims to provide water treatment apparatus including a modular water treatment unit which is particularly suited to use in treating and cleaning water used in car washing apparatus or equipment. Other objects and advantages of the invention will become apparent from the following description.

The present invention thus provides in a first aspect, a modular water treatment unit including a modular tank having a plurality of joined tank parts defining respective chambers arranged in a series for treating water, each said tank part and having opposite side walls, adjacent side walls of adjacent said tank parts being joined at their common upper ends, said common upper ends of said tank parts defining weirs over which water being treated in said unit may flow from one tank part to he adjacent tank part for treatment in the respective said chambers.

The term “water” as used throughout the specification includes contaminated water or any other water or liquid carrying impurities or solids.

Preferably the tank parts of me modular tank are integrally formed. Preferably the tanks parts are integrally formed of plastics for example in a rotational moulding process. Thus the joined upper ends of the side walls are joined by being integrally formed.

In one embodiment, each weir defined by the joined upper ends of the walls of respective tank parts is at a lower level relative to a horizontal plane than the upstream weir or weirs whereby the water will flow under the influence of gravity from one tank part to the next tank part over the respective weirs. Alternatively the respective weirs may be at substantially the same horizontal level. Preferably the adjacent side walls of the adjacent tank parts arc inclined downwardly and outwardly from their joined upper ends.

Preferably baffle means are provided in at least one tank part to divide the water treatment chamber of the one tank part into chamber parts on opposite sides of the baffle means from one chamber part to the adjacent chamber part. Preferably the baffle means are arranged such that water flows in use beneath or through a lower end portion of the baffle means. The baffle means suitably comprise planar baffles or panels. A baffle or panels may be elevated above the lower end of the tank part in which it is located whereby water may flow from one chamber part to the adjacent chamber part beneath the baffle or panel. Alternatively a baffle or panel may be provided with through apertures or with slots or cut out portions in its lower end for flow of water therethrough. Preferably the tank part is provided with upright slots or grooves in its opposite sides in which opposite side edges of the baffle means may be located to be supported in a tank part.

Preferably one of the tank parts comprises an enlarged main tank part. The main tank part suitably defines a main chamber which has an increased volume compared to the volumes of the chambers of the other tank parts. A water inlet suitably supplies water to be treated to the main tank part. Preferably a screen filter is associated with the main tank part for filtering of water from the water inlet for flow into the main chamber. The screen filter suitably comprises a drain filter assembly. The drum filter assembly suitably comprises a rotatable filter drum having a screen or mesh material extending peripherally of the drum and a water inlet is provided for supplying water to be treated to the filter drum to pass through tile screen or mesh material. Suitably means are provided for supporting and rotating the drum. Such means may comprise motor means for causing rotation of the drum. Preferably however the drum is driven in rotation by water flowing into the drum. Preferably the water inlet suitably comprises a supply pipe which extends into the interior of the drum. The drum filter is suitably of a type disclosed in our International patent application No. PCT/AU02/01245. Other forms of drum filter however may be employed .

Means may be provided for cleaning the screen or mesh material of the drum. The means for cleaning the screen or mesh material may include means for spraying water an/or applying pressurized air onto the screen or mesh material. Suitably means within the drum are provided for collecting materials displaced from the screen or mesh material. The means for collecting the material may comprise a trough or channel supported within the drum. The trough or channel suitably extends in an axial direction within the drum. The trough or channel may direct materials collecting therein to waste. Water for cleaning of the screen or mesh material may be supplied from an external clean water source. Alternatively water for cleaning the screen or mesh material may be derived from water within the main chamber. For this purpose, a pump may be provided in a lower portion of the main chamber.

The screen or filter drum may be supported over the main chamber which collects water filtered by the screen or drum filter. The filter drum may be supported on a frame over the main chamber. The frame may carry rollers upon which the filter drum of the drum filter assembly is supported for rotation. The frame may be supported on a shoulder at the upper end of the main tank.

The main chamber may comprise a biological filter. The biological filter may be defined by biological filter media in the main chamber which is adapted to carrying bacteria for biological treatment of water filtered by the screen or drum filter. Typically the bacteria for treating water in the main chamber comprises anaerobic bacteria. Where the water to be treated is contaminated with oil, the biological filter media may support oil-eating bacteria for treatment of oil in water passing into the main chamber. Upright baffle means may be provided in the main chamber. The biological filter medium may be located on one side of the baffle means. Preferably the baffle means are arranged such that water flows in use beneath or through a lower end of the baffle means. The baffle means suitably comprise a panel suitably a planar pane. The panel may be elevated above the lower end of the main tank part so that water may pass beneath the panel. Alternatively the panel may be provided with through apertures or with slots or cut out portions in its lower end for flow of water therethrough. Preferably the main tank part is provided with upright grooves in its opposite sides in which opposite side edges of the panel may be located to be supported in a tank part.

Means associated with the main tank part may also be provided for supporting or holding further biological media for carrying other bacteria for biological treatment of water from the screen or drum filter. The supporting or holding means may be located above the main chamber. The supporting or holding means may support or hold biological filter media adapted to carry further bacteria, typically anaerobic bacteria for biological filtering of water from the screen or drum filter prior to passage to the main chamber. The supporting or holding means may comprise a water pervious means which may my the biological filter media. The water previous means may comprise a perforated or mesh panel or the like. The perforated or mesh panel may comprise a bottom panel of a container which contains the biological filter media. The screen or drum filter may be supported on the container. Suitably the container seats on the main tank part.

Selected chamber parts of one or more of the other tank parts may include means for exposing water in the chambers part to ozone. Selected chamber parts of the one or more of the other tank parts may include means for exposing water in the chamber part to air. Selected chamber parts of the one or more of the other tank parts may include means to expose the water in the chamber part to ultraviolet light.

The main chamber may include means for exposing the water in the main chamber to air or ozone. Ozone from an ozone source such as an ozone reactor/s or generator/s may be supplied to the lower end of the main chamber to bubble upwardly through that chamber. Ozone may be supplied to an air or gas block submerged in the main chamber or through an outlet or outlets in the lower portion of the main chamber. Alternatively air may be supplied to the air or gas block for bubbling through water in the main chamber where the main chamber carries aerobic bacteria on the biological filter media therein. The biological filter media may comprise a plurality of discrete elements such as a plurality of plastic tubes, a mesh material or other elements.

Preferably the chambers or chamber parts in which water is exposed to ozone comprise chambers in which water is flowing downwardly in the chamber with the ozone outlets being provided at lower portions of the chambers. The chambers in which water is exposed to ozone may include a flow-restricting medium such as a plurality of discrete elements or other flow restricting means to increase the period that water in the chambers is exposed to ozone.

Preferably a water outlet communicates with the last or trailing chamber or chamber part of the series of chambers. The outlet may extend outwardly of the trailing tank part having the titling chamber or chamber part. The last or trailing chamber or chamber part may include means to expose the water therein to ultraviolet light. Such means may comprise one or more ultraviolet lamps. The ultraviolet lamp or lamps may be supported in an upright attitude in the chamber or chamber part.

Water for treatment in the water treatment unit flows in a serpentine manner through the unit by passing over respective wires and passing beneath or through the lower ends of respective baffle means.

The present invention in another aspect provides water treatment apparatus comprising a floatable support for location in a body of water to be treated, said floatable support caring a modular water treatment unit of the above described type. Preferably a water inlet to the water treatment unit communicates with the body of water. The water inlet to the water treatment unit may be communicate with the body of water via one or more pumps. The pumps may be submergible pumps. The pumps may be supplied with power from one or more batteries on the vessel, platform or buoyant body. The battery or batteries may be solar charged. Preferably the outlet from the water treatment unit directs treated water back into the body of water.

The floatable support suitably includes buoyant bodies such as floats. The floats may be provided on opposite sides of the floatable support. The floats may comprise elongated floats or a plurality of separate floats. The floats may be provided on opposite sides of the water treatment unit. A walkway may extend peripherally of the floatable support and at least partially around the water treatment unit.

Preferably where the water treatment unit includes a main tank, the main tank is arranged at one end of the floatable support. Additional floats may be provided at the one end of the floatable support. Preferably the floatable support includes transverse support arms which extend between respective tank parts such that adjacent tank parts straddle a support arm. Preferably the joined upper ends of the adjacent walls of adjacent tank parts define saddles which seat on the respective support arms. Preferably opposite ends of the support arms are supported by the opposite side floats. Opposite ends of the support arms may scat within transverse grooves in the floats. Alternatively the support arms may be part of a frame of a platform including a walkway supported on floats. The floats typically are plastic air containing floats but may be other forms of floats.

The present invention provides in another preferred aspect, water treatment apparatus comprising a holding container for holding water to be treated, at least one foam fractionator or separator for receiving water from said holding container and at least one water treatment unit of the type described above for receiving water from said at least one foam fractionator.

Preferably water for treatment in the apparatus flows under the influence of gravity from the holding container to the treated water outlet. The outlet or outlet from the modular water treatment unit may be selectively connected to the holding container such that water to be treated is recirculated through the apparatus before exiting the treated water outlet for reuse.

The holding container suitable comprises a hopper-like tank having a waste outlet at its lower end. The hopper-like tank is suitably supported in an upright attitude by a support frame. The lower end of the container suitably is of tapering cross section suitably of conical form to taper to the waste outlet. A water outlet is suitably provided at the upper end of the tank for connection to the at least one foam fractionator or separator. The water outlet is suitably arranged to communicate with water in the holding tank at a position below the upper level of water in the holding tank. The water outlet is suitably connected through a trap to the at least one foam fractionator.

The at least one foam fractionator or separator suitably comprises an upright container having an inlet at an upper end connected to the water outlet of the tank and a waste outlet at its lower end. The foam fractionator or separator container suitably includes an inner hollow member located preferably coaxially within the fractionator or separator container which divides the tank into an inner and outer chamber with the inlet communicating with the inner chamber and the waste outlet communicating with the outer chamber. An air supply may be provided to assist in the passage of waste from the waste outlet. Means may also be provided for applying water such as a spray of water to the waste to assist passage of the waste through the waste outlet

Preferably a water outlet from the foam fractionator or separator is provided at the lower end of the inner chamber.

Preferably means are provided to introduce air into the inner chamber for bubbling through the water therein against the flow of water from the inlet towards the water outlet. Preferably the air introducing means comprises air inlet means at the lower end of the inner clamber. The air inlet means may comprise one or more air stones or other form of air outlet. Contaminants in the inner chamber will be conveyed by bubbles of air to the upper end of the chamber and over the upper edge of the inner member (which acts as a weir) into the outer chamber for passage to the waste outlet.

Preferably, the foam fractionator container comprises a cylindrical tank and the inner hollow member comprises a hollow cylindrical member suitably arranged coaxially within the tank.

In an alternative arrangement, a baffle may be provided in the foam fractionator container to divide the container into a first chamber which receives water from the holding container and a second chamber having the waste outlet. The first chamber suitably includes the water outlet and an air outlet or outlets is provided in the lower end of the first chamber for the passage of air in the form of bubbles of air through the first chamber.

Preferably, the apparatus includes at least two foam fractionators or separators and the liquid outlet of one foam fractionator or separator is connected to the inlet of the second foam fractionator or separator such that the foam fractionators or separators are arranged in series for further treatment of the water. Preferably the water flows from the water outlet of the first foam fractionator or separator to the water inlet of the second foam fractionator or separator under the influence of gravity. For this purpose, the water inlet to the second foam fractionator or separator is below the upper end of the inner or second chamber of the first or preceding foam fractionator or separator.

The water outlet from the foam fractionator or fractionators is suitably connected to the inlet to the water treatment unit. Water exiting the outlet of the water treatment unit may be connected to the holding container for re-treatment in the apparatus.

### BRIEF DESCRIPTION OF THE DRAWINGS

In order that the invention may be more readily understood and put into practical effect reference will now be may to the company drawings which illustrate preferred embodiments of the invention and wherein:

FIG. 1 is an isometric view of a modular water treatment unit according to an embodiment of the invention with the top cover removed;

FIGS. 2 and 3 are end and side views of the unit of FIG. 1;

FIGS. 4 is an isometric view of water treatment apparatus incorporating the modular water treatment unit of FIGS. 1 to 3;

FIG. 5 is a top view of the apparatus of FIG. 4;

FIGS. 6 and 7 are end and side views of the apparatus of FIG. 3 in the directions A and B respectively;

FIG. 8 is an isometric view of a foam fractionator or separator of the apparatus of FIG. 4;

FIGS. 9 and 10 are side and top views of the foam fractionator or separator;

FIG. 11 illustrates schematically the operation of the water treatment apparatus and associated water treatment unit of FIGS. 4 and 1;

FIG. 12 is an isometric exploded view of an alternative water treatment apparatus according to the invention;

FIGS. 13 to 15 are end, top and side views respectively of the apparatus of FIG. 12;

FIG. 16 is a ghost outline view of the apparatus of FIG. 12;

FIGS. 17 and 18 are isometric and isometric exploded views of a further embodiment of water treatment apparatus;

FIGS. 19 to 21 are end, side and top views respectively of the apparatus of FIG. 17;

FIG. 22 is an exploded isometric view of a modular water treatment unit for use in the apparatus of FIGS. 16 and 17;

FIG. 23 is a ghost outline view of the unit of FIG. 22;

FIGS. 24 is a side view of the unit of FIG. 22

FIG. 25 is a side view of a further embodiment of modular water treatment unit according to the invention;

FIG. 26 is an exploded view of the unit of FIG. 25;

FIG. 27 is an enlarged view of a biological media holder for the unit of FIG. 26;

FIG. 28 illustrates the unit of FIG. 25 associate with a floatable support;

FIG. 29 is an enlarged sectional view of the water treatment apparatus of FIG. 28 showing the water flow through the water treatment unit;

FIG. 30 is an isometric view of a further water treatment unit according to the invention;

FIGS. 31 and 32 are side and end views of the unit of FIG. 30

FIG. 33 is an isometric view of the unit of FIG. 30 with the top cover removed;

FIG. 34 illustrates in isometric view, water treatment components of the unit of FIG. 30; and

FIG. 35 is a cross sectional view of the unit of FIG. 32.

### DETAILED DESCRIPTION OF THE PREFERRED EMBODIMENTS

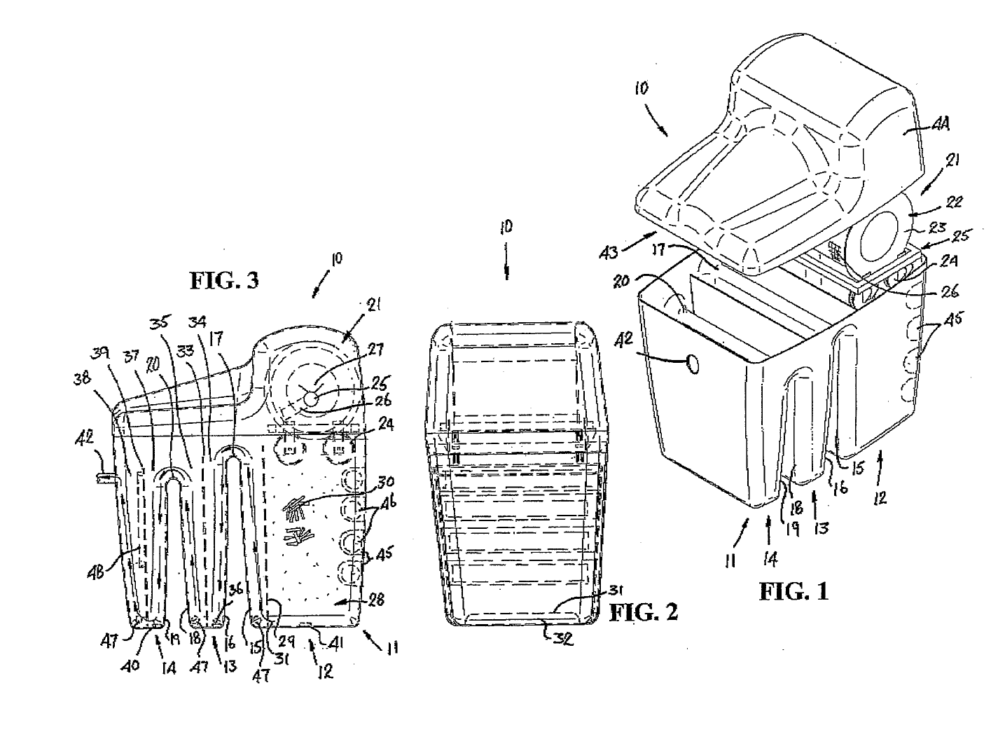

Referring to the drawings and firstly to FIGS. 1 to 3, there is illustrated a modular water treatment unit 10 according to an embodiment of the invention which comprises a self contained unit which includes a modular base tank 11, the tank 11 including a first main tank part 12 and second and third tank parts 13 and 14. The tank parts 12, 13 and 14 are preferably integrally formed with the tank 11 such as by being rotationally moulded from plastics. The tanks parts 12, 13 and 14 are separated from each other with opposing side walls 15 and 16 of the adjacent tank parts 12 and 13 being spaced apart but integrally joined at their common upper ends 17. Similarly opposing side walls 18 and 19 of the tank parts 13 and 14 are spaced apart but integrally joined at their common upper ends 20. It will be apparent however that the walls 15 and 16 are of a greater height than the walls 18 and 19 so that the upper end 20 of the walls 18 and 19 is below the upper end 17 of the walls 15 and 16.

A drum filter assembly 21 which is of similar configuration to the drum filter assembly disclosed in our International Patent Application No. PCT/AU02/01245 is supported above the main tank part 12 and comprises a filter drum 22 which includes annular end members 23 supported externally on rollers 24 mounted on a frame 25 which seats on a shoulder in or on the upper end of the tank part 12. A screen or mesh material 26 is provided between the end members 23 and extends peripherally of the drum 22.

Water is supplied to the drum 22 via an inlet duct 25 (see FIG. 3), the duct 25 having longitudinally spaced outlets 26 through which water may flow from the duct 25 to cooperate with ribs within the drum 22 to effect rotation of the drum 22.

A hopper-like channel 27 for catching debris from the drum screen material 26 is located above the inlet duct 24 and also extends in an axial direction into the drum 22. A spray bar or bars (not shown) is be provided above the drum 22 for spraying water and/or applying a blast of air to the screen material 26 of the drum 22 to displace materials which are caught by the channel 27. The spray bars may be connected to a pump and a clean supply of water and/or to an air compressor or air pump. The channel 27 may be connected to a waste collection chamber or a sewer.

The dram filter 21 is supported over a chamber 28 which is defined within the tank part 12 on one side of an upright baffle 29 therein to receive water filtered through the drum filter 21, the side edges of the baffle 29 being located in grooves in the opposite sides of the tank part 12. The chamber 28 contains media 30 for carrying bacteria for biological treatment of water in the chamber 28 and for slowing flow of water through the chamber 28. The bacteria typically is an anaerobic bacteria for example an oil eating bacteria to remove oil in the water but in some embodiments may be aerobic bacteria. The media 30 may be any form of bacteria carrying media and typically comprises a plurality of small lengths of plastic tube or other members.

The lower end of the baffle 29 is provided with a cut-away part or recess 31 which defines with the base of the tank part 12 a slot-like opening 32 through which water from the chamber 28 passes to flow upwardly as indicated by the arrows in FIG. 2 and 3 and over the common end 17 of the walls 15 and 16 which defines a weir into the tank part 13. The tank part 13 is separated by a central upright baffle 33 into chamber parts 34 and 35 with the baffle 33 being of similar configuration to the baffle 29 so that water flows down the chamber part 34 under the baffle 33 and up the chamber part 35.

The chamber part 34 includes in its lower region, ozone outlets 36 through which ozone exits to pass upwardly through the water flowing downwardly through the chamber part 34. The ozone outlets 36 maybe any form of outlet such as one or more air stones. To increase the contact time between the ozone and water flowing through the chamber part 34, the chamber part 34 includes a flow restricting media such as a plurality of separate elements for example small plastic tubes, mesh or any other flow restricting means. The flow of water under the influence of gravity is limited by the media so that extended contact time is provided between the ozone flowing upwardly through the chamber part 34 and water flowing downwardly through the chamber part 34.

The tank part 14 is similarly divided into chamber part 37 and parts 38 by a central baffle 39 with again ozone outlets 40 being provided in the lower part of the chamber part 37 whereby water flowing downwardly through the chamber part 37 is exposed to ozone. The chamber part 37 through which water flows downwardly also may include flow restricting media as used in the chamber part 34.

Further ozone outlets 41 may be provided in the chamber 28 for passage of ozone upwardly through the chamber 28. The outlets 36, 40 and 41 may alternatively connected to an air supply if desired to selectively enable bubbles of air to flow upwardly through the chamber parts 34 and 37.

An outlet 42 is provided in the outer wall of the tank part 14 below the wall ends 20 so that treated water can flow under the influence of gravity from the unit 10.

The unit 10 further includes a removable cover 43 which covers the tank 12 and which includes an enlarged end 44 to accommodate and cover the drum filter 21.

For supply of ozone to the ozone outlets 36, 40 and 41, the outer side of the main tank 12 adjacent the drum filer 21 is provided with a series of elongated indentations or recesses 45 which can house ozone generators 46, the ozone generators 46 being in the form of tubes through which air is passes, the tubes housing ultraviolet lamps to convert the oxygen in the air flowing through the tubes into ozone.

To assist flow of water upwardly from the chamber 28 and over the upper end 17 of the walls 15 and 16, one or more air outlets 47 such as an air stone or stones may be provided at the lower end of the chamber 28 on the outer side of the baffle 29 and connected to a source of pressurized air. Similar air outlets 47 may be provided at the lower ends of the chambers 35 and 38 for the same purpose.

The water flowing upwardly through the chamber part 38 may also be exposed to ultraviolet light for final treatment provided by ultraviolet lamps 48 which extend downwardly into the chamber part 38.

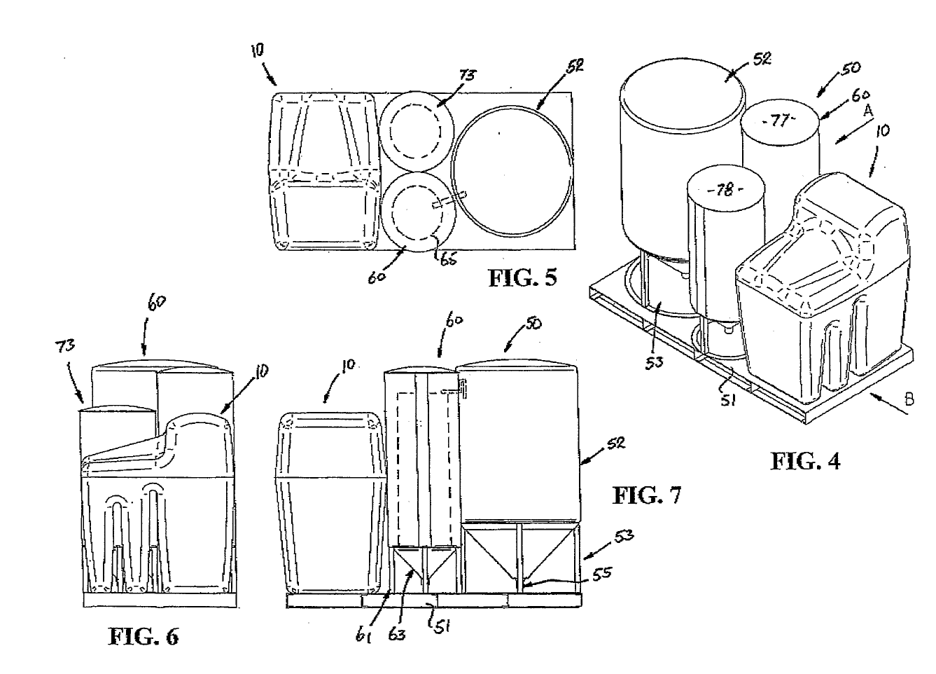

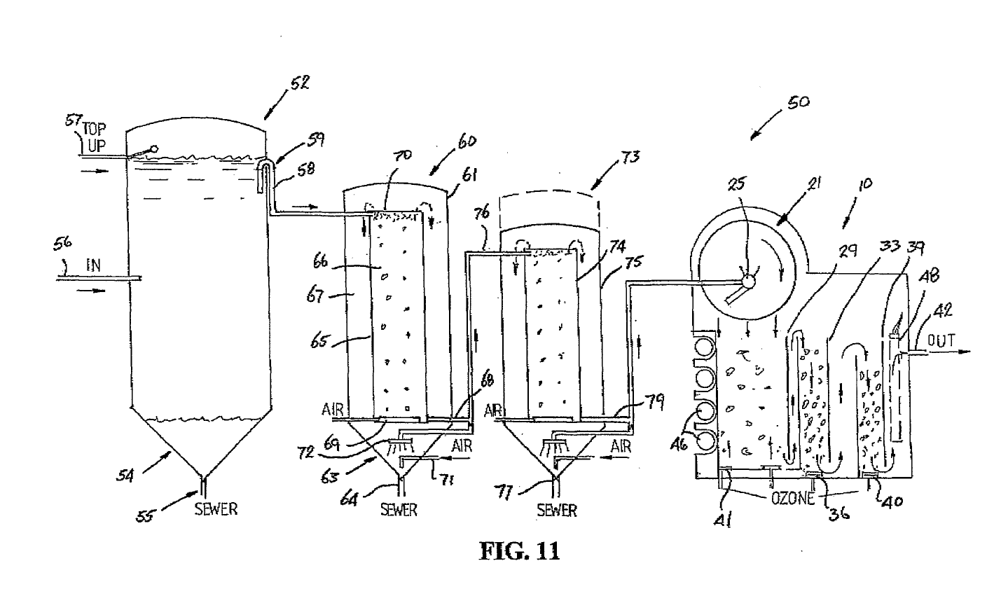

The modular water treatment unit 10 described above has many different applications for treating water and one application illustrated in FIGS. 4 to 11 is used with apparatus 50 for treating water from a vehicle washing establishment, the water usually containing soap and detergent suds used in the washing process as well as grease, oil, brake pad dust, road grime and other contaminants. The apparatus 50 is supported on a platform 51 upon which it may be readily transported and includes a holding tank 52 of hopper-like form and which is of generally cylindrical configuration and supported in an upstanding attitude on a support frame 53. The lower end 54 of the tank 52 is of conical form and terminates in a valve-controlled waste outlet 55 which may be connected to a sewer line or waste collection tank. The tank 52 is provided with a first inlet 56 for water to be treated. The tank 52 is also provided with a second inlet 57 for top up water such as water from a mains supply and the inlet 57 is controlled by a float valve so that the level of water in the tank 52 is maintained at a predetermined level. The tank 52 also includes an outlet 58 which incorporates a trap 59 and which communicates via the trap 59 with the water in the tank 52 at a level lower than the surface level of the water so that the outlet 58 is not contaminated by materials floating on the surface of the water.

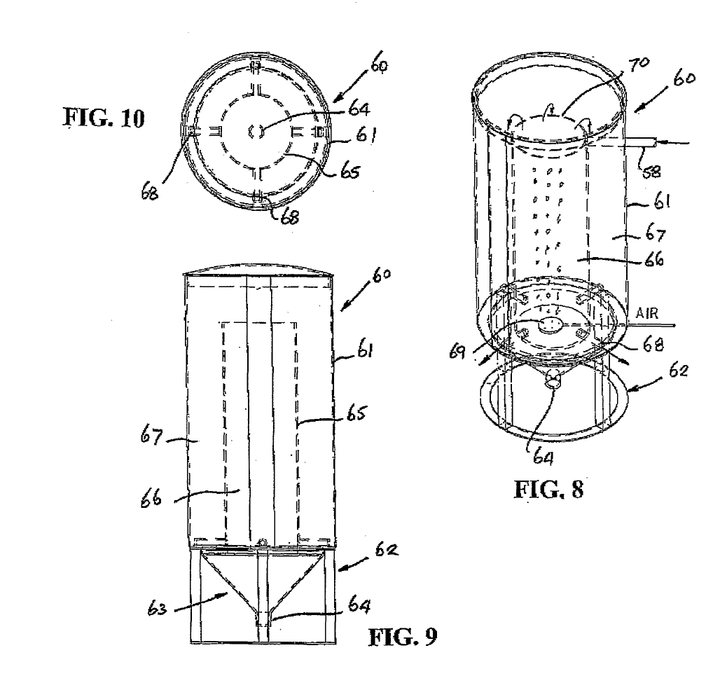

A first foam fractionator/separator 60 is supported adjacent the tank 52, the fractionator 60, as also shown in FIGS. 8 to 10 including an outer cylindrical tank 61 which also is supported on a support frame 62 in an upright attitude and which includes a conical portion 63 at its lower and terminating in a valve controlled waste outlet 64 which may also be connected to a sewer or waste collection tank. Located coaxially within the tank 61 is an inner cylindrical tank or wall 65 which is coaxial with the tank 61, the inner tank 65 being closed at its lower end. The tank 65 thus defines an inner chamber 66, and an outer annular chamber 67 between the walls of the inner tank 65 and outer tank 61. The lower end of the inner tank 65 is connected to a series of outlet pipes 68 whilst water from the tank 62 is supplied to the upper end of the tank 65 from the tank outlet 68. The lower end of the tank 65 also includes outlets 69 typically in the form of one or more air stones which is or are connected to a supply of air whereby bubbles of air can bubble through the water flowing into the upper end of the tank 65 from the outlet 69. Bubbles of air reaching the surface of water in the tank 65 create a foam which carries solid contaminants in the water over the top edge 70 of the tank 65 into the chamber 67 for passage out of the waste outlet 64. An air line 71 having an outlet adjacent the waste outlet 64 assists in conveying contaminant materials out of the waste outlet 64. A water spray head 72 may also be provided adjacent the waste outlet 64 for flushing the lower end of the tank 61 through the waste outlet 64. The spray head 72 is connected through a valve to the water outlet line 68 or alternatively may be connected to a mains water supply.

The apparatus 50 also includes in this case a second foam fractionator/separator 73 of the same configuration as the fractionator 60 and including an inner tank or wall 74 located within an outer tank 75. The outlet pipes 68 of the fractionator 60 are connected to an inlet 76 to the fractionator 73 so that water from the fractionator 60 is supplied to the inner tank 74 of the fractionator 73 under the influence of gravity, the outlet 76 being lower than the connection of the inlet 68 to the tank 65. The foam fractionator 73 also includes a valve controlled waste outlet 77 which is connected to a sewer line or waste collection chamber. The fractionator 73 functions in the same inaner as the fractionator 60 with bubbles of air passing upwardly through water flowing into the inner tank 74 of the fractionator 73 from the fractionator inlet 76. The outer tank 75 of the fractionator may be of the same height as the tank 61 as shown in dotted outline or of a lower height as illustrated. The foam fractionators 60 and 73 are also provided with covers or lids 77 and 78. The water outlets 79 from the fractionator 73 (which are similar to the outlets 68) are connected to the water treatment unit 10 by being connected to the inlet duct 25 of the drum filter 21.

In use, contaminated water is initially supplied to the tank 52 so that solids or heavier materials will collect in the lower conical portion 54 of the tank 52 from which it may be removed via the outlet 55 which is valve controlled. Water from an upper portion of the tank 52 flows to the first foam fractionator 60 for exposure to bubbles of air which remove contaminants which are also exhausted through the outlet 64 which is also a valve controlled outlet with the assistance of air from the inlet 71 and/or water from the water spray 72. Cleaner water from the fractionator 60 flows under the influence of gravity to the fractionator 73 for further treatment with wastes passing through the valve controlled outlet 77.

Water then flows from the fractionator 73 to the modular waste treatment unit 10 for treatment in the drum filter 21 and exposure to bacteria in the tank part 12 and ozone in the tank parts 13 and 14 and possible exposure to ultraviolet light in the chamber 38. Cleaned water then flows from the outlet 42.

The outlet 42 may be connected back to the inlet 56 to the tank 52 for further cleaning. In practice, water may be recirculated through the apparatus 50 four to six time before being withdrawn from the apparatus 50 for use. To maintain the level of water in the holding tank 52, water is added through the inlet 57 if the float valve associated with the inlet 57 detects a drop in water level.

Whilst the embodiment shows two foam fractionators, only one such fractionator may be provided or alternatively more than two such fractionators may be provided. The filtering or treatment components however may also be arranged in a different sequence depending upon the application. A further water treatment unit 10 may also be provided before the holding tank 52 so that water flowing into the holding tank 52 is initially filtered in the unit 10.

The modular treatment unit 10 whilst described in FIGS. 4 to 11 in association with the apparatus 50 may be used as a stand-alone water treatment unit in different applications for water treatment purposes.

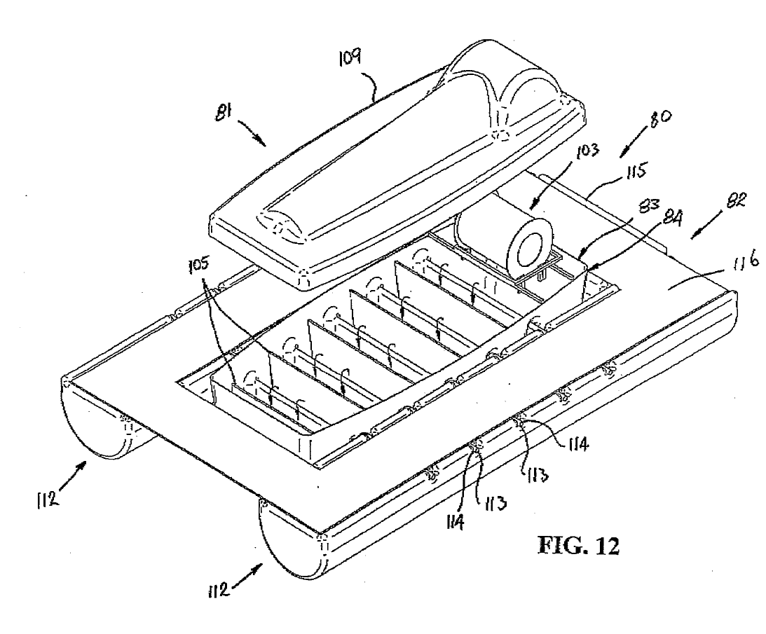

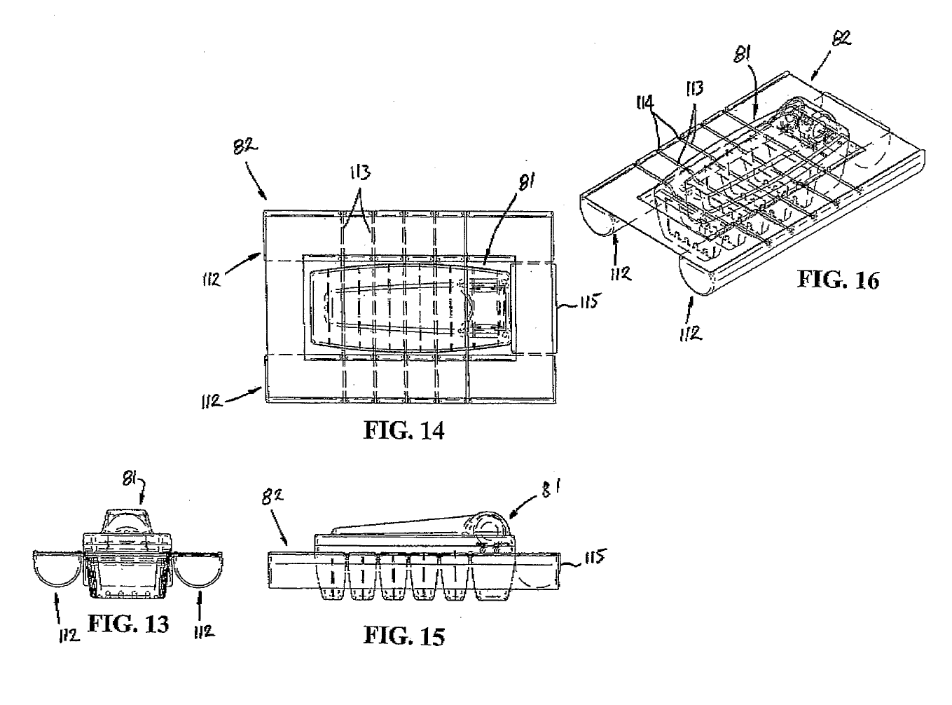

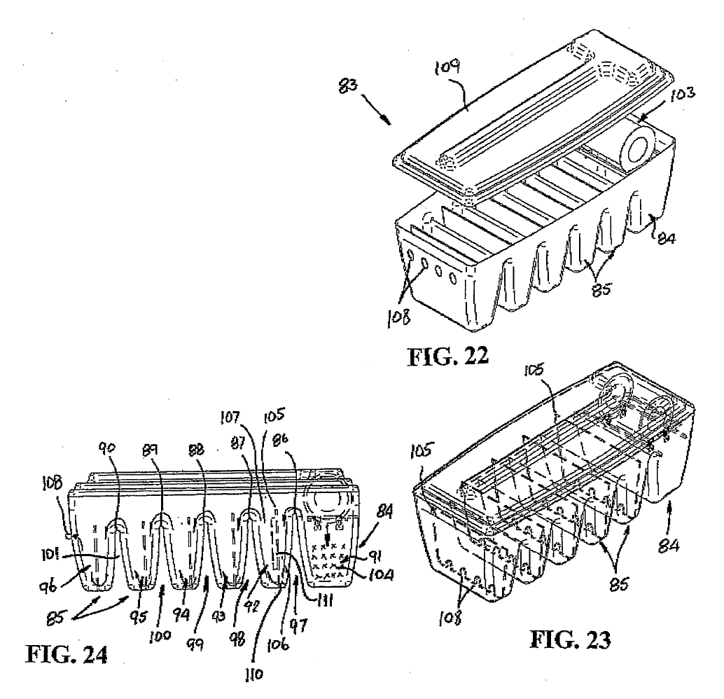

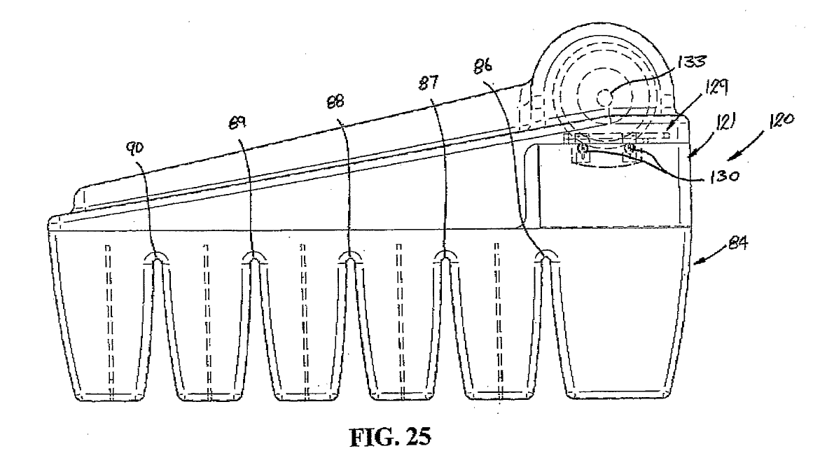

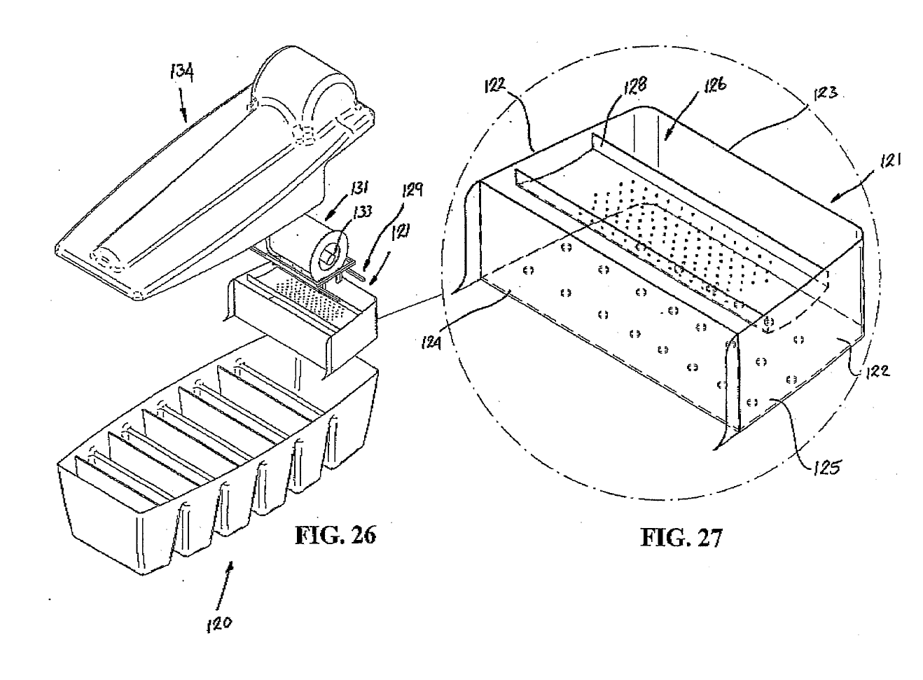

Referring now to FIGS. 12 to 25, there is illustrated a water treatment apparatus 80 according to another embodiment of the invention which includes a modular water treatment unit 81 similar to the unit 10 described above which is supported on a floatable support or structure 82 for floating in a body of water to be treated. The modular water treatment unit 80 includes a one piece tank 83 which may comprise a single plastics moulding and which as shown in FIGS. 22 to 26 includes a main tank part 84 and a series of further interconnected tank parts 85. Adjacent end walls of the respective tank parts 84 and 85 are joined at their corresponding upper ends 86, 87, 88, 89 and 90 with each end 87, 88, 89 and 90 being successively of a height less the adjacent end 86, 87, 88, and 89 respectively away from the main tank part 84 (see FIG. 26). The main tank part 84 defines a main chamber 91 and each tank part 85 defines respective chambers 92, 93, 94, 95 and 96 and a series of transverse channels 97, 98, 99, 100, and 101 are defined between adjacent walls of the respective tank parts.

A drum filter 103 similar to that previously described is supported over the chamber 91 of the main tank part 84. The chamber 91 contains medium 104 for carrying bacteria for biological treatment of water in the chamber 91 and for slowing flow of water through the chamber 91.

An upright transverse baffle 105 is provided in each chamber 92, 93, 94, 95 and 96. Thus each chamber for example the chamber 92 is divided into chamber parts 106 and 107 on opposite side of the baffle 105. The baffles 105 in the other chambers 93, 94, 95, and 96 similar define each chamber into two chamber parts. The lower end of the baffle 105 is provided with a series of cut-out portions 108. Alternatively, the cut-out portions 108 may be replaced by openings in the lower ends of the baffles 105. In another arrangement the baffles 105 may be raised above the bottom of each tank part so that water may flow under the lower edges of the baffles 105. Outlets 108 for water are provided in the outer wall of the last tank part 85, the outlets 108 being below the upper end 90 of the last two joined tank parts 85.

The unit 81 further includes a removable cover 109 which is shaped to cover and enclose the tank parts 84 and 85 and the drum filter 103, the cover 109 illustrated in FIGS. 20 to 25 being of a slightly different configuration to that of FIG. 12.

As is illustrated in FIG. 24, water flowing through the drum filter 103 passes into the main tank part 91 where it is subject to bacteriological treatment from bacteria growing on the media 104. The water then flows river the upper end 86 of the wall of the tank 84 down into the chamber part 106, through the cut-out portions 108 in the baffles 105 and up the chamber part 107 over the next end 87 etc. The water thus flows as indicated by the arrows in FIG. 20 in a serpentine manner through each tank part 85 flowing downwardly on one side of tie respective baffles 105 and upwardly on the other side of the respective baffles 105. This flow continues until treated water flows outwardly through the outlets 108.

The chamber part 106 (and corresponding parts in the other chambers 93, 94, 95 and 96) have gas outlets 110 it its lower end through which ozone or ozone enriched air can pass upwardly through the water flowing into the chamber part 106. The chamber part 106 may carry a media to limit flow so that extended contact time is provided between the ozone flowing upwardly through the chamber part 106 and water flowing downwardly through the chamber part 106. The outlets 110 may also be connected to an air supply if desired to selectively enable bubbles of air to flow upwardly through the chamber part 106.

The chamber part 107 (and corresponding chamber parts of the other tank parts 105 may include ultraviolet lamps 111 so that water flowing upwardly through a chamber part 107 (and corresponding chamber parts of the other tank parts 105) is exposed to ultraviolet light.

The modular water treatment unit 81 may be used on land however in the embodiment of FIGS. 12 to 21 is adapted to be mounted on the floatable structure 82 which in FIGS. 12 to 16 includes a pair of elongated floats 112 on each side of a semi-circular cross section and transversely extending support members or rods 113 extend through each channel 97, 98, 99, 100 and 101 of the unit 81 and seat within transverse grooves 114 in the top of the floats 112. So that the modular water treatment unit 81 is oriented substantially horizontally in use, the ends 86, 87, 88, 89 and 90 may lie in a common substantially horizontal plane or may be of varying heights as in FIG. 24. The support members or rods 113 are located at the apexes of the side walls of the respective tank parts 84 and 85 beneath the ends 86, 87, 88, 89 and 90 which act as saddles to seat on the rods 113. The tanks 84 and 85 when the apparatus 117 is floating on a body of water are substantially submerged within the water.

An additional float 115 is provided between the floats 112 at the drum filter end of the apparatus 80 to provide additional buoyant support in this region. A peripheral walkway 116 is additionally provided on top of the floats 112 and 115 to surround the water treatment unit 81.

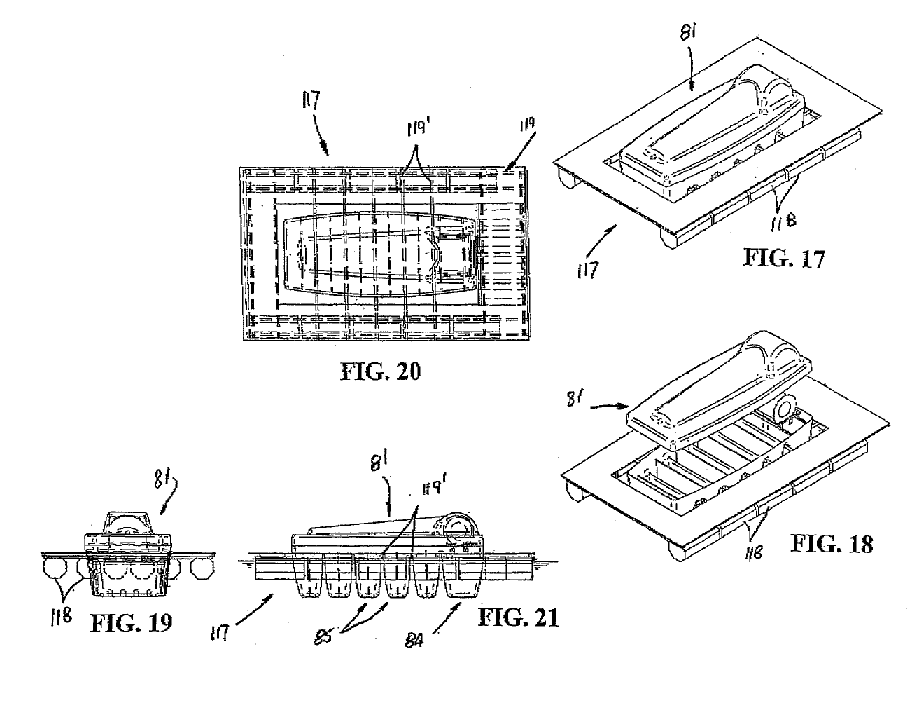

The embodiment of water treatment apparatus 117 of FIGS. 17 to 21 is similar to the embodiment of FIGS. 12 to 16 however in this case the floats 118 comprise a plurality of individual floats. The apparatus 117 has a support frame 119 which includes transverse members 119′ for location in the channels between respective tank parts 84 and 85, the floats 117 being secured to the support frame 118.

In use the water treatment apparatus 80 (or 117) of FIGS. 12 to 21 is arranged to float in a body of water to be treated and may be self-powered to move around the body of water or moved by other means around the body of liquid. Alternatively the apparatus may be anchored or moored in a fixed position. A submergible pump (not shown) is provided to pump water to the drum filter 103 which subsequently passes through the respective chambers of the tank parts 84 and 85 for treatment. Alternatively a pump may be mounted on the floating structure 82. Power for the pumps may be provided by shore power or batteries or a generator supported on the floating structure 82. Water passing through the unit 81 will be continuously treated with treated water flowing back to the body of water through the treated water outlets 108.

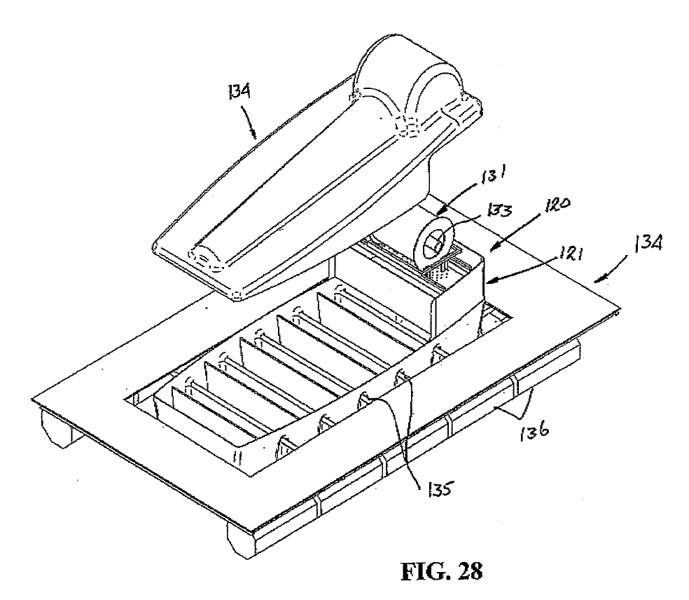

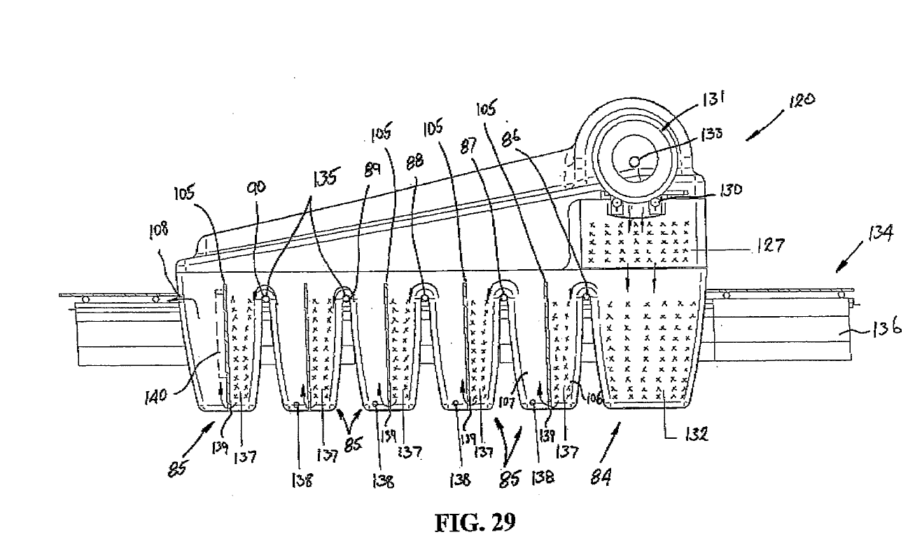

FIGS. 25 to 29 illustrate a further embodiment of water treatment unit 120 according to the invention which is similar to the unit 81 of FIGS. 20 to 25 and in which like components to that of the unit 81 have been given like numerals. In this case however the upper ends 86, 87, 88, 89 and 90 lie in substantially the same horizontal plane. In addition, a biological media holder 121 is seated on the tank part 84. The media holder 121 has opposite side walls 122 and an end wall 123 which when the holder 121 is seated on the tank part 84 are aligned with and constitute extensions of the side and end walls of the tank part 84. The holder 122 additionally includes an end wall 124 spaced from and parallel to the wall 123 and a bottom wall 125 such that the holder 121 defines a chamber 126 for holding the biological media 127 (see FIG. 29). The bottom wall 125 is apertured or perforated to enable water to pass therethrough into the part 84.

The holder 121 additionally includes an apertured tray 128 extending between and fixed to the side walls 122 at a position towards the upper end of the holder 121. Seated removeably on the tray 128 is a frame 129 which carries rollers 130 upon which a filter drum 131 is rotatably supported.

The biological media 127 in the holder 121 carries aerobic bacteria. Further media 132 is provided in the tank part 84 being normally submerged in water and which carries anaerobic bacteria.

An inlet 133 for water to be treated extends into the interior of the filter drum 131. The cover 134 is designed to cover the tank parts, the holder 121 and the filter drum 131 so that all water treatment components are enclosed and covered.

The unit 120 may be supported on a floatable structure 134 in a similar manner to that shown in FIGS. 17 to 21 for floating on a body of water to be treated for treating of water therein with transverse rods or arms 135 locating between the respective tank parts 84 and 85 beneath the wall ends 86, 87, 88, 89 and 90 and being supported on opposite sides by floats 136.

In use and as shown also in FIG. 29, water is supplied to the filter drum 131 from a pump submerged in the body of water and through the inlet 133 for initial solids filtering with filtered water passing through the apertured tray 128 into the bacteria holder 121 for bacteriological treatment by aerobic bacteria supported on the media 127 therein. This treated water then passes into the tank part 84 for further bacteriological treatment by anaerobic bacteria supported on the media 132 therein.

The bacteriologically treated water then passes out of the main tank part 84 to the respective following tank parts 85 in the manner illustrated by the arrowheaded line in FIG. 29 over the upper ends 86,87,88, 89 and 90 of the tank parts which act as weirs and beneath or through the lower ends of the respective baffles 105 to exit through the outlets 108 back into the body of water. Water passing through the respective tank parts 85 is exposed to ozone, air and/or ultraviolet light in the manner described with reference to FIG. 24.

The chambers 106 of the tank parts 85 nay also carry biological media 137 for supporting further anaerobic bacteria for treating water flowing downwardly through the chambers 106 for farther bacteriological treatment of water. Gas outlets 138 are provided in the lower ends of the chambers 107 for supply of ozone-enriched air to bubble through water in the chamber 107 which has passed from the chamber 106 beneath or through the baffles 105 at the lower end of the chambers 106 and 107. The gas outlets 138 may be of any configuration and may he simple nozzles, gas or air stones, or gas permeable pipes. For conveyance of water from one chamber 106 to the adjacent chamber 107 in a tank part 85, the lower ends of the baffles 105 are provided with a series of cut-out portions or openings 139 through which water can flow from one chamber 106 to the adjacent chamber 107. In another arrangement the baffles 105 may be raised above the bottom of each tank part 85 so that water may flow under the edge of a baffle 105. The final chamber 107 may contain one or more ultraviolet lamps 140 for ultraviolet treatment of water before it exits the unit 120 through the outlets 108.

In an alternative arrangement the gas outlets 138 may be in the lower portions of the chambers 106 with the media in the chambers 106 limiting flow of water so that extended contact time is provided between the ozone enriched air flowing upwardly from the outlets 138 through the chambers 106 and water flowing downwardly through the chamber 106. The gas outlets 138 may also be connected to an air supply if desired to selectively enable bubbles of air to flow upwardly through the chambers 106 or 107. In this configuration, the chamber parts 107 may include ultraviolet lamps 140 so that water flowing upwardly trough the chamber parts 107 is exposed to ultraviolet light in the manner described previously.

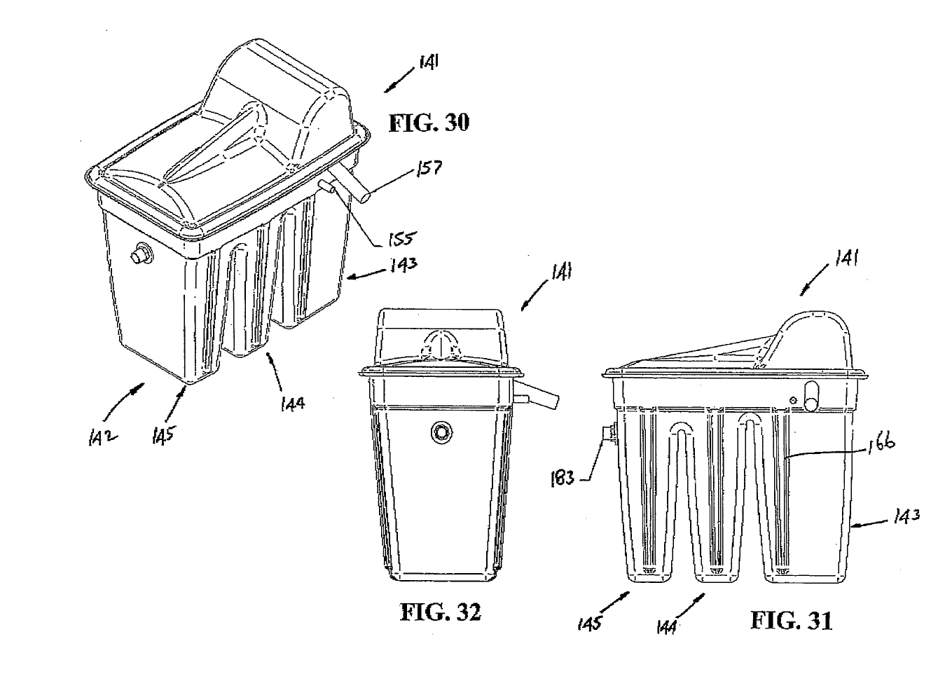

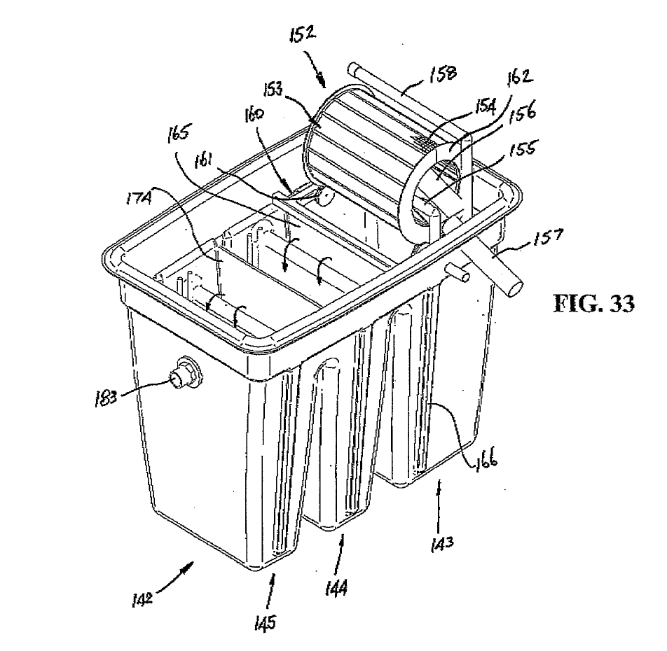

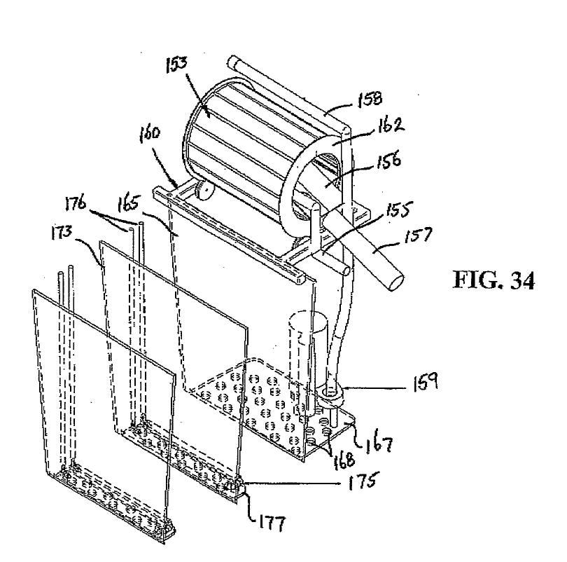

The water treatment unit 141 shown in FIGS. 30 to 35 is similar to the unit previously described and includes a base tank 142, the tank 142 including a first main tank part 143 and second and third tank parts 144 and 145. The tank parts 143, 144 and 145 are integrally formed such as by being rotationally moulded foam plastics. The tanks parts 143, 144 and 145 are separate from each other with opposing side walls 146 and 147 of the tank parts 143 and 145 being spaced apart but integrally joined at their common upper end 148 with the side walls 146 and 147 being inclined outwardly and downwardly away from each other from their upper end 148. Similarly opposing side walls 149 and 150 of the tank parts 144 and 145 are inclined away from each other but integrally joined at their common upper end 151 with the upper ends 151 of the walls 149 and 150 being below the upper end 148 of the walls 146 and 147.

A drum filter assembly 152 which is of similar configuration to the drum filter described above is supported above the main tank part 143 and comprises a drum 153 having a screen or mesh material 154 around its periphery. Water is supplied to the drum 153 via an inlet duct 155 which extends into the interior of the drum 153 and out of the side of the tank 142 so that water exiting the inlet duct 155 causes rotation of the drum 153 by acting against paddles or ribs within drum 153 around which the screen or mesh material 154 is wrapped. An inclined bopper-like channel 156 for catching debris displaced from the drum screen material 154 extends into the drum 153 and connected to a waste outlet 157 which also extends out through the side of the tank 152. A spray bar or bars 158 is provided above the drum 153 for spraying water onto the screen material 154 to displace materials from the screen material 154 which are caught by the channel 156 and directed to waste through the waste outlet 157. Water for spraying through the spray bar 158 may be supplied from externally of the unit 141 or may be derived from water in the tank part 143 through a pump 159 located in a lower region of the tank part 143.

The drum filter assembly 152 includes a support frame 160 which carries pairs of grooved rollers 161 in which annular end members 162 of the drum 153 are supported for free rotation. The frame 160 seats on a shoulder 163 in the tank pat 143 and above a chamber 164 defined in the tank part 143 on one side of an upright baffle 165 therein to collect water filtered through the drum filter 153, the baffle 165 being located in grooves 166 in opposite sides of tank part 143. In this embodiment, the baffle 165 is impervious to water but includes an extending bottom wall 167 having a plurality of openings 168 therein. The chamber 164 contains media 169 for carrying bacteria for biological treatment of water in the chamber 164 and for slowing flow of water through the chamber 164, the media 164 being supported on the perforated bottom wall 167. The media 164 may be in the form of short sections of plastics tubing so as to float within the water but may be of an alternative form. In another arrangement, a separate panel of mesh or grid material may be supported in the lower end of the chamber 164 above the bottom wall thereof in place of die wall 167. The bacteria used in the chamber 164 typically are aerobic bacteria. Air outlets 170 such as air stones are provided in the lower end of the chamber 164 for supply of air to the chamber 164 for bubbling through water therein and assist the aerobic bacteriological action.

The bottom wall 167 is elevated above the base of the tank part 143 or provided with a cut-away part or recess to enable water to flow under the baffle 165.

The tank part 144 includes chambers 171 and 172 separated by an upright dividing baffle 173 which is received in opposite grooves 174 in the tank part 144. Gas outlets 175 are provided in a lower region of the chamber part 171 being connected through supply pipes 176 to a supply of ozone or ozone enriched air. The tank part 171 also carries media similar to the media 169 for carrying bacteria for biological treatment of water flowing through the chamber part 171. In this case the bacteria carried by the media in the chamber part 171 may comprise anaerobic media. The lower end of the baffle 173 includes a perforated right angled lower wall 177 on which the media seats.

The tank part 145 is of similar form to the tank part 144 with a dividing baffle 178 dividing the tank part 145 into two chambers 179 and 180 with gas outlets 181 for ozone enriched air provided in the chamber 179.

Ultraviolet lamps 182 are provided in the chamber part 180 for ultraviolet treatment of water before it exits through treated water outlet 183 in the outer wall of the tank part 145 positioned below the upper wall end 151.

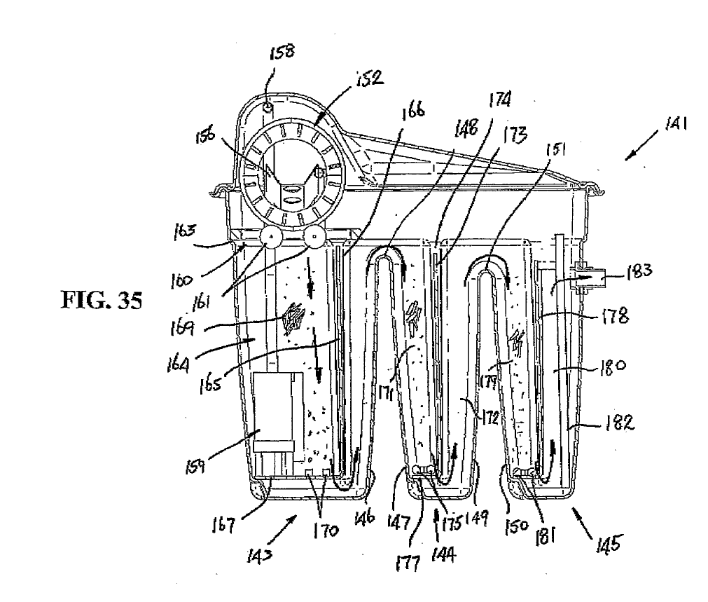

In use and as shown by the arrowheaded lines in FIG. 35, water to be treated initially is pumped or flows into the inlet duct 155 through which it exits in the filter drum 152 causing its rotation and being filtered through the drum screen material 154 to pass into the chamber 164 for biological treatment. The water then flows in a serpentine manner where it is exposed to further biological treatment, ozone treatment and exposure to ultraviolet light before exiting through the outlet 183.

The unit 141 may be land based apparatus or may be supported on a floatable structure in a similar manner to that described above.

The modular water treatment units may be of various configurations other than those illustrated and described an may have any number of water treatment tanks parts in addition to the main tank part. In some embodiments, the main tank parts may be eliminated with water being treated by passage through the series of further tank parts. Whilst the baffles in the tank parts are preferably detachable pane-like members, they may be integrally formed or moulded with the tank parts.

Reference to the prior art herein is not to be taken as an acknowledgment that such prior art constitutes common general knowledge in the art.

The terms “comprising” or “comprises” or derivatives thereof as used throughout the specification and claims are taken to specify the presence of the stated features, integers and components referred to but not preclude the presence or addition of one or more other feature/s, integer/s, component/s or group thereof.

Whilst the above has been given by way of illustrative embodiment of the invention, all such variations and modifications thereto as would be apparent to persons skilled in the art are deemed to fall within the broad scope and ambit of the invention as herein described in the appended claims.

1-25. (canceled)

26. A modular water treatment unit comprising:
a modular tank having a plurality of integrally connected tank parts defining respective water treatment chambers arranged in series for treating water passing through said water treatment unit,
each said tank part having opposite side walls, each said side wall having an upper end, adjacent side walls of adjacent said tank parts being integrally connected at said upper ends to define weirs over which water being treated in said unit can flow in use from one tank part to the adjacent tank part for treatment in the respective said water treatment chambers defined by said respective tank parts.

27. A modular water treatment unit as claimed in claim 26 and including an upright baffle in at least one tank part dividing the water treatment chamber of the one tank part into chamber parts on opposite sides of said baffle.

28. A modular water treatment unit as claimed in claim 27 wherein said baffle is arranged in said one tank part such that water for treatment flows in use beneath or through a lower end portion of the baffle from one chamber part to the adjacent chamber part of said one tank part whereby water flows downwardly through one said chamber part and upwardly through the other said chamber part.

29. A modular water treatment unit as claimed in claim 28 wherein said one tank part has a lower end and wherein said baffle comprise a planar panel, said planar panel being elevated above said lower end of said tank part whereby water may flow from one chamber part to the adjacent chamber part beneath the panel.

30. A modular water treatment unit as claimed in claim 29 wherein said baffle comprises a planar panel provided with through apertures or with slots or cut out portions in its lower end for flow of water therethrough.

31. A modular water treatment unit as claimed in claim 27 wherein said tank part has opposite sides, said opposite sides being provided with upright slots or grooves in which opposite side edges of the baffle are located to support said baffle in an upright position in said tank part.

32. A modular water treatment unit as claimed in claim 27 wherein a chamber part of said tank part includes one of an ozone outlet for flow of ozone through water in the chamber part, a biological filter media adapted to carry bacteria for treatment of water in said chamber part, or an ultraviolet light source.

33. A modular water treatment unit as claimed in claim 26 wherein one of said tank parts comprises a main tank part defining a main chamber of increased volume compared to the volumes of the chambers of the other tank parts and a screen filter for filtering said water to be treated prior to flow into said main chamber.

34. A modular water treatment unit as claimed in claim 33 wherein said screen filter comprises a drum filter assembly having rotatable filter drum, a support frame for supporting said drum filter above said main tank part, said support frame carrying rollers upon which said filter drum is supported for rotation.

35. A modular water treatment unit as claimed in claim 34 wherein said main chamber comprises a biological filter including biological filter media carrying anerobic bacteria for biological treatment of water filtered by said screen filter.

36. A modular water treatment unit as claimed in claim 35 and including a holder above said main chamber for holding further biological filter media carrying aerobic bacteria for biological treatment of water from the screen filter prior to passage to the main chamber.

37. A modular water treatment unit as claimed in claim 27 wherein one of said tank parts comprising a trailing tank part and wherein a water outlet is provided in a side wall of the trailing tank part for outlet of treated water.

38. Water treatment apparatus comprising a floatable support for location in a body of water, said floatable support carrying a modular water treatment unit as claimed in claim 26 for treatment of water in said body of water.

39. Water treatment apparatus as claimed in claim 38 wherein said floatable support includes spaced floats, transverse support arms which extend between said floats, respective adjacent tank parts being located on opposite sides of a said support arm, the joined upper ends of the side walls of adjacent tank parts defining saddles which seat on said support arms.

40. A modular water treatment unit comprising:
a modular tank having a plurality of integrally connected tank parts defining respective water treatment chambers arranged in series for treating water passing through said water treatment unit,
each said tank part having opposite side walls, each said side wall having an upper end, adjacent side walls of adjacent said tank parts being integrally connected at said upper ends to define weirs over which water being treated in said unit can flow in one use from one tank part to the adjacent tank part for treatment in the respective said water treatment chambers defined by said respective tank parts,
a first end tank part of said series of tank parts comprising an enlarged tank part defining a main treatment chamber, said main treatment chamber comprising a bacteriological treatment chamber,
a rotatable drum filter mounted above said main treatment chamber,
an inlet for supplying water to said drum filter for filtering thereby prior to passage to said main treatment chamber, and
an outlet for treated water in a second end tank part of said series of tank parts.

41. A modular water treatment unit as claimed in claim 40 and including a holder supported on the upper end of said main tank part for holding bacteriological media and defining a further bacteriological treatment chamber, said drum filter being supported on and above said holder.

42. A modular water treatment unit as claimed in claim 40 wherein further said tank parts of said series of tank parts include upright baffles dividing each said tanks part into respective chamber parts on opposite sides of said baffle, said baffles being arranged in said tank parts such that water for treatment flows in use beneath or through a lower end portion of a baffle from one chamber part to the adjacent chamber part of said one tank part and water flows downwardly through one said chamber part and upwardly through the other said chamber part,

43. A modular water treatment unit as claimed in claim 42 wherein one or more of said chamber parts including one of an ozone outlet for flow of ozone through water in the chamber part, a biological filter media adapted to carry bacteria for treatment of water in said chamber part, or an ultraviolet light source.

44. Water treatment apparatus comprising:
a float assembly including spaced apart floats, and
a plurality of support arms extending between said spaced apart floats;
a modular water treatment unit supported by said float assembly, said modular water treatment unit including a modular tank having a plurality of integrally connected tank parts defining respective water treatment chambers arranged in series for treating water passing through said water treatment unit,
each said tank part having opposite side walls, each said side wall having an upper end, adjacent side walls of adjacent said tank parts being integrally connected at said upper ends to define weirs over which water being treated in said unit can flow in use from one tank part to the adjacent tank part for treatment in the respective said water treatment chambers defined by said respective tank parts,
respective adjacent tank parts of said modular tank being located on opposite sides of said respective said support arms, said integrally connected upper ends of said tank parts defining saddles seating on respective said support arms.

45. Water treatment apparatus as claimed in claim wherein one of said tank parts comprises a main tank part defining a main chamber of increased volume compared to the volumes of the chambers of the other tank parts, said main chamber comprising a bacteriological filter chamber and a screen filter for filtering said water to be treated prior to flow into said the main chamber.
